(19) United States
(12) Patent Application Publication
(10) Pub. No.: US 2019/0063399 A1
(43) Pub. Date: Feb. 28, 2019

(54) Crankless engine

(71) Applicant: John Galveston Doud, Brownsboro, TX (US)

(72) Inventor: John Galveston Doud, Brownsboro, TX (US)

(21) Appl. No.: 15/685,259

(22) Filed: Aug. 24, 2017

(51) Int. Cl. F03C 1/06; F02B 75/26; F02B 75/32; F16H 25/08

(52) U.S. Cl. CPC F03C 1/061; F02B 75/26; F01L 3/00; F16H 25/08; F02B 75/32

(57) ABSTRACT

The crankless sinusoidal engine has at least one cylinder, one standard piston and head with combustion chamber and inlet and exhaust valves. A main shaft with one flywheel with incorporated sinusoidal track, Connection between the piston and the sinusoidal track consists of four items; to wit, one connecting rod, one bearing trolley and two segmented rollers, said rollers being in constant contact with said sinusoidal track, one bearing on each side thereof. The bearing trolley sliding on guide pins anchored in opposite ends of cast (alternatively fabricated) housing, said guide pins positioned parallel to the main shaft.

Pressure from the piston forces the segmented rollers against the sinusoidal track, causing rotation.

### FIELD OF INVENTION

The invention relates to a crankless reciprocating machine having one or more cylinders. A main shaft is located parallel to, and spaced from, the longitudinal axis of the cylinder(s). The main shaft and pistons are so interconnected that reciprocation of the piston imparts rotary motion to the main shaft or vice versa, with a housing that may be either cast or constructed as desired.

The invention includes simplicity of design and ease of manufacture.

The machine of the invention may be an internal combustion engine, air or liquid cooled, or external combustion engine.

### DESCRIPTION OF THE PRIOR ART

Conventional reciprocating machines generally use a crank mechanism to convert reciprocating motion into rotary motion or vice versa. While those mechanisms are simple to manufacture, they are inefficient in the transfer of force to the load, and generally, it is necessary to employ balancing counterweights. While it has long been recognized that some form of sinusoidal track, groove or cam will cause rotation of a shaft or drum, the problem of successfully applying force from the reciprocating member to the aforesaid track in a design that is economically feasible has been elusive. If that were not the case, there would be sinusoidal type engines on the market today. This invention addresses that problem and also the problem of complexity of past inventions.

It has been proposed in U.S. Pat. No. 3,598,094 (ODAWARA) to provide a crankless reciprocating machine with a mechanism for converting a reciprocating motion into a rotary motion or vice versa. The mechanism calls for a pin connected to a piston and extending radially from it. A sinusoidal groove is formed in a part surrounding the piston. The pin travels in the cam groove so that reciprocating motion of the piston produces rotary motion.

The use of a pin running in an endless groove is also described in U.S. Pat. No. 1,529,687 (BOWEN), and U.S. Pat. No. 2,401,466 (C B Davis, et al).

The disadvantages of these arrangements are; pins small enough to use in this application, and particularly being mounted at only one end are not strong enough to withstand the forces in any modern engine, and a pin in a groove or slot is in contact with the sliding surface at only one very tiny point. It will wear rapidly and cause flat spots and resulting loose fits that cannot be tolerated. If a roller is used in a slot instead of a pin, it cannot operate with close tolerances within a slot, because the opposite sides of the slot would try to rotate the roller in opposite directions at the same time causing primarily sliding rather than rolling motion causing excessive wear.

U.S. Pat. No. 4,090,478 (TRIMBLE) shows a sinusoidal groove with rollers on pins connected to the pistons, said pins extending through the cylinder wall. There are three objections to this arrangement.

Slots in the cylinder wall would require double the length of each piston and cylinder to keep combustion pressure from bypassing the piston rings and leaking through the slot. That would greatly increase the length of the engine.

As the pistons move in the cylinder, the pins would be forced against the slot, first one side and then the other, and would quickly wear beyond use.

As I pointed out earlier, rollers will not roll successfully within a slot unless there is additional clearance between slot and roller, and such extra clearance would be destructive to the machine.

U.S. Pat. No. 5,031,581 (Powell)

One argument against this engine is the sheer complexity of manufacturing. Manufacturers have shown that they are unwilling to spend more when the expected results do not justify the added expense.

Powell uses tapered rollers mounted on the connecting rod running against a tapered sinusoidal track thus solving the problem of different circumferences. There are some problems with this design however.

The tapered track and rollers have to be tapered in a direction that would force them apart under load, that movement being controlled by ways within the housing and on the connecting rod. It appears from the drawings that the connecting rods are integral with the pistons. That makes it impossible to use standard pistons, and also causes the sides of the pistons to accept the load from the side forces of the tapers on track and rollers. The other end of the connecting rods run in ways machined or attached within the housing, making the machining and alignment of the ways to the rods more difficult than it has to be, allowing no alignment tolerance between piston and sinusoidal track, thus adding manufacturing expense.

### BRIEF SUMMARY OF INVENTION

It is an object of the invention to provide a lightweight, powerful, simple crankless sinusoidal engine having means other than a crank mechanism to convert reciprocating motion to rotary motion and does not involve the deficiency of a pin or roller running in an endless cam groove, and does not involve unnecessary complex manufacturing procedures.

It is also the object of the invention to provide a means of varying the torque output and the stroke of the engine, each factor being independent of the other. It is possible to raise the torque output without adding cubic inches causing additional fuel consumption.

The invention provides a crankless sinusoidal engine. The engine is sinusoidal in that conventional crankshaft design is replaced by an endless sinusoidal track.

The invention provides a method of designing the engine so that the piston(s) may travel more than one complete cycle during one rotation of the main shaft.

The invention provides means of altering the torque output of the engine without changing the distance traveled by the piston(s). Also, by modifying the configuration of the track, the motion of the pistons may also be modified.

The invention provides for a crankless sinusoidal engine comprising at least one cylinder, a main shaft mounted parallel to, and spaced from, the longitudinal axis of each cylinder, one endless, substantially sinusoidal track integrated with a flywheel that is rigidly attached to the main shaft for rotation therewith, said track being interconnected with said piston(s) so that reciprocation of the piston(s) imparts rotary motion to the main shaft and vice versa, characterized in that said substantially sinusoidal track is axially spaced from each cylinder and comprises a radially extending flange contoured in an axial direction to define the endless, substantially sinusoidal track, the radially extending face of the flange, a connecting rod connected at one end to a piston and the other end being connected to a roller trolley, said trolley having two segmented rollers attached to it, said rollers being in constant contact with the two sides of the sinusoidal flange.

A crankless reciprocating engine wherein said segmented rollers are composed of a stack of thin washers held together to form a roller that self compensates for the different distance each end of the roller must travel around the inner and outer circumferences of said sinusoidal track.

The crankless sinusoidal engine may have a single cylinder and be either air cooled or liquid cooled. Alternatively, the engine may have a plurality of such cylinders. In either case, the axis of each cylinder is arranged parallel to the main shaft at a space. In the case of multiple cylinders, they would be arranged in a circular fashion around the main shaft. The multi cylinder engine is dynamically balanced regardless of the number of cylinders without using counterweights. The single cylinder engine is easily balanced with a dummy trolley mounted in such a position that it travels in the opposite direction from the working cylinder and trolley. The crankless sinusoidal engine can be built using many components readily available. When built as an air cooled engine, the need for a cast housing and the added expense of molds or dies may be avoided. The only complex item required is the sinusoidal track, that being machined on the flywheel.

The alternative housing for said engine may be constructed using heavy tubing with bolted and/or welded end pieces for a round housing, or plates bolted and/or welded, forming a cubic housing.

### BRIEF DESCRIPTION OF THE DRAWINGS

FIG. 1 illustrates a single cylinder embodiment of the invention; a cross longitudinal section showing relationship of the major parts.

FIG. 2 shows a sectioned view of the roller trolley, rollers and guide pins

FIG. 3 shows detail of segmented rollers.

FIG. 4 shows major pieces for fabricated housing

### DETAILED DESCRIPTION OF THE DRAWINGS

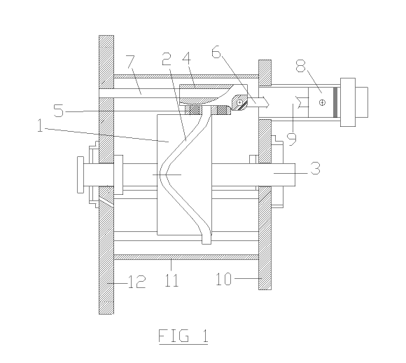

In FIG. 1, the sectioned view is through the centerline of the engine in the same plane as the main shaft.

The crankless sinusoidal engine illustrated in FIG. 1 comprises a main shaft (3) mounted in bearings in the housing (illustrated as 10, 11, & 12), a flywheel (1) securely mounted on the main shaft (3), a sinusoidal track (2) integrated with the flywheel (1), which is in constant engagement with the segmented rollers (5) that are mounted on the trolley (4) which slides on and is guided by two guide pins (7) that are anchored at each end in the housing (or end plates 10, & 12). The trolley is attached to connecting rod (6) the other end of connecting rod (6) being attached to the piston (8) which reciprocates in the cylinder (9).

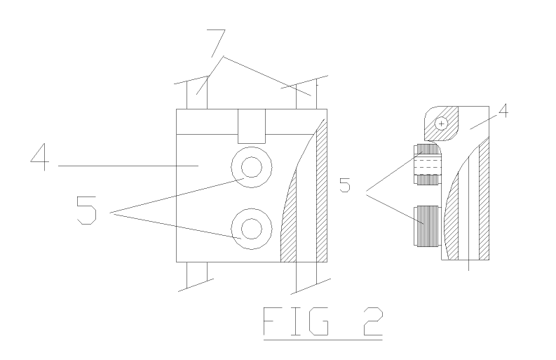

FIG. 2 shows tow partially sectioned views of the trolley (4) with attached segmented rollers (5) and partial views of guide pins (7).

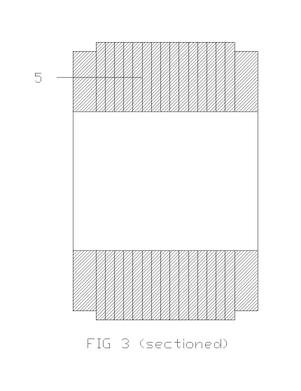

FIG. 3 shows sectioned roller (5), detailing the manner of construction of the segment stack forming the rollers.

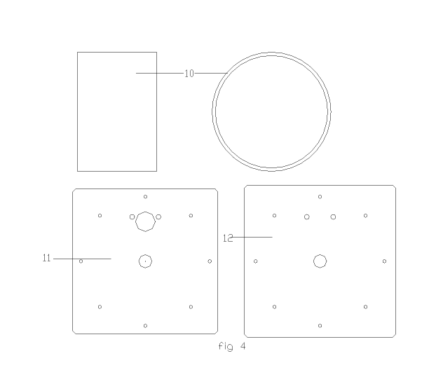

FIG. 4 shows tubing (10), front plate (11), and back plate (12) used to fabricate optional housing.

It will be appreciated that the invention is not limited to the embodiments of the invention that have been described and illustrated in the accompanying drawings. Various changes and modifications within the broad scope of the invention described will be apparent to a person skilled in the art.

I claim:

1. A crankless sinusoidal engine comprising at least one cylinder, complete with head and inlet and exhaust poppet valves. A main shaft mounted parallel to the cylinder, one flywheel with incorporated sinusoidal track, mounted near the center of the main shaft, one connecting rod attached to the piston at one end and to a bearing trolley at the other by means of a wrist pin, said bearing trolley having two segmented rollers spaced so as to fit snugly, one against each side of the sinusoidal track. The bearing trolley is mounted on two guide pins so that it will slide parallel to the main shaft and cylinder. The guide pins are rigidly mounted in and between the front and back ends of the housing. Force from the piston through the connecting rod, bearing trolley, and segmented bearings against the sinusoidal track cause the track, flywheel, and main shaft to rotate, all enclosed in a housing.

2. A crankless sinusoidal engine as claimed in claim 1, characterized in that it comprises one or more cylinders located around the main shaft.

3. A crankless sinusoidal engine as claimed in claim 1, characterized in that the driving mechanism comprises a segmented roller constantly in contact with one cam surface and a second segmented roller in constant contact with the opposed cam surface.

4. A crankless sinusoidal engine as claimed in claim 1, characterized in that the sinusoidal track has a continuously variable thickness to match the spacing between the two segmented rollers mounted on the bearing trolley at all points during rotation.

5. A crankless sinusoidal engine as claimed in claim 1 where the bearing trolley is a separate part from both the connecting rod and the sinusoidal track.

6. A crankless sinusoidal engine as claimed in claim 1, characterized in that the rollers are segmented to provide velocity at each end appropriate to the different distances traveled around the sinusoidal track.

7. A crankless sinusoidal engine as claimed in claim 1, characterized in that the engine may be adapted to operate with multiple cycles of the piston(s) with each rotation of the main shaft.

8. A crankless sinusoidal engine as claimed in claim 1 where the alternative housing embodiment is a simple, constructible housing that may be desired when manufacturing volume does not justify the expense of the preferred cast housing.
